(19) United States
(12) Patent Application Publication
(10) Pub. No.: US 2009/0273226 A1
(43) Pub. Date: Nov. 5, 2009

(54) Distributed Load Wheel

(76) Inventors: Gregory Krantz, (US); David Houcque, (US); Dennis Rockwell, Kanasaville, WI (US)

Correspondence Address: STELLANA U.S., 999 WELLS STREET, LAKE GENEVA, WI, 53147, US

(21) Appl. No.: 12/113,248

(22) Filed: May 1, 2008

(51) Int. Cl. B60B 11/00; B60B 19/00

(52) U.S. Cl. 301/5.1; 301/36.1

(57) ABSTRACT

This specification relates to the improvement of load wheels. The current design of load wheels results in the most of load being born by the ends of the wheel. The invention distributes the load across the entire load wheel assembly, thereby reducing friction. Reducing friction extends the service life of the load wheel.

### BACKGROUND OF THE INVENTION

This invention pertains to load wheels for material handling vehicles, and more particularly to the improving the service life of the load wheel by better distribution of the load carried across the wheel. Load wheels are devices with no individual moving parts. Load wheels are used in all Class II material handing vehicles; for example, a fork lift or an order picker. Load wheels are also used in all Class III material handing vehicles such as, a palette jacks or lift trucks. Load wheels are used to support the material moved, or handled by the truck or vehicle. Unlike tires, load wheels do not brake articulate or turn. The current design, exemplified by FIGS. 4-6, of a load wheel comprises a machined or extruded metal hub. The design further comprises a through shaft supported by bearings about which an axis of free rotation is maintained. In addition, the outer diameter of the hub is covered with a plastic, rubber or other elastomer that provides a load bearing surface. The wheel assembly is mounted into a yoke that is part of the material handling vehicle.

A state of the art hub, as in FIGS. 4-6, can be described as an open ended cylinder. Usually, a hub is round with a cylindrical cavity that is concentric with the outside diameter of the hub, and is open on both ends. It is common that each end of the hub encompasses one or more bearings pressed into each end of the cavity. The bearings and the cavity are of sufficient diameter to allow a through shaft to be inserted through the center of the cavity. The shaft provides an axis that allows free rotation about the shaft.

The outer diameter of the hub, shown by FIG. 4 is usually coated with either plastic, rubber, or other elastomer that acts as a tread material. The current industry best practice is to bond the tread material to the hub using an adhesive. The tread material provides a wear surface for the load wheel, and bears the load placed on the wheel. In addition, the tread material provides traction, cushioning, and vibration damping. The tread material also allows the load wheel to run on multiple surfaces while not damaging the substrate floor. It also aids in the optimization of steering and control system for the vehicle.

A trend in the material handling industry is to run the material handling vehicles at higher speeds; for longer periods of time; and for longer distances. For example, the standard running speed for a lift truck was six (6) miles per hour. Currently, the standard speed is nine (9) miles per hour. In the near future, it is expected that the speed will increase to eleven (11) miles per hour, with goal to be eventually fifteen (15) miles per hour. In addition to speed, material handling vehicle owners are designing the warehouses to have longer runs than in the past. A run is the distance between the start and stopping points of the truck while performing its function. As a result, the average operating temperature of load wheels has increased and will continue to increase as the standard speed of the lift truck increases and as the length of the run increases. The increase in operating temperature provides a daunting challenge to the current state of load wheel design.

Due to the increased operating temperature, load wheels are failing more rapidly. The changes the standard operating of material handling vehicles will create unacceptably short service life for load wheels. The invention described herein mitigates the problem of heat build up caused by current designs for load wheels. A load wheel designed under the current art, as in FIGS. 4-6, is a single wheel with the bearing placed at each end. This results in the majority of the load being borne by the ends of the wheel. While running the shaft bends slightly in the middle of the wheel causing increased friction at the ends of the load wheel. The increased friction generates heat that causes the wheel to fail. In addition, in certain applications, the outer diameter of the load wheel is limited to three and one quarter (3¼) inches. The limitation is necessary so that the load wheel can fit under a standard shipping palette. On the other hand, a load wheel may be of any length.

A distributed load wheel, exemplified by FIGS. 1-3, mitigates the problems described above by distributing the load more evenly across the shaft and face of the wheel. The load is distributed, by using a plurality of wheels and bearings across the through shaft. The more even distribution of load eliminates the bending of the shaft under load. By not bending the shaft, the amount of friction on the ends of the wheel is reduced. The reduction in friction mitigates the rate of heat build up in the wheel. As a result, the running temperature of the wheel is reduced. The reduction in running temperature increases the service life of the wheel.

The multiple wheels also reduce friction during turns made by the vehicle. When making a turn, the portion of the wheel on the outer arc of the turn must move faster to keep up with the portion of the wheel that is in the inner portion of the arc of the turn. Current design uses a single wheel. A single wheel can only run at one speed, as a result, during a turn, the outer portion of the wheel slides or drags across the floor to keep up with the inner portion of the wheel during the turn. The sliding or dragging increases friction on the wheel and thus increases the running temperature of the wheel and thus reduces service life.

By using multiple wheels, the outer wheel can run at a different speed than the inner wheel; in addition, the wheels are free to counter rotate. This speed differential and or counter rotation, eliminates the sliding or dragging of the outer portion of the load wheel. Elimination of the sliding or dragging of the wheel reduces friction. Reduction in friction decreases the running temperature of the wheel. The reduced running temperature increases the service life of the wheel.

In addition to using multiple wheels, the load can be more uniformly distributed across the length of the wheel though the use of an inner core, as in FIGS. 9-15, within the hub. The inner and outer diameter of the core is concentric with the inner and outer diameter of the hub. The through shaft will be sliding fitted with the core. Thus the inner core must have a center core support member made up of a cylindrical cavity open at both ends of the hub that is concentric with the inner and outer diameter of the hub and of sufficient inner diameter to allow the shaft to be sliding fitted through the inner core to provide an axis of rotation. The center core support member is attached to the inside diameter of the outer hub means of a rib. In addition distributing the load, the inner core also absorbs shocks and impacts across the entire face of the load wheel, making the load wheel durable due to the improvement in impact resistance.

In addition to reducing the rate of temperature build up, a distributed load wheel design provides a number of other benefits over to current load wheel designs. One benefit being the materials of construction used to make the hub. Unlike castors which carry loads less than 1,000 pounds, load wheels currently carry loads of 1,000 to twenty thousand 20,000 pounds. To carry these heavy loads, the hubs typically are constructed from machined or non-machined metal, typically cast iron, steel, stainless steel, or aluminum.

Using a distributed load design, however, allows the use of non-metallic materials. By more evenly distributing the load across the shaft, the use of metal is not necessary. For example, the hubs can be made out of unfilled or filled engineering thermoplastics. In addition, natural materials such as wood or resin impregnated fibers could be used to form the hub. Thermoset filled or unfilled plastics or cured rubber could be used to make the hub as well.

Load wheel hubs have been made from engineering thermoplastics such as nylon. A load wheel hub made of nylon, based on the prior art design as in FIGS. 4-6, with the bearings on the ends of the load wheel, has several limitations. First, the loads carried are limited to 1,200 lbs. This load limitation is due to loss of stiffness inherent in plastic materials at elevated temperatures. The nylon deflects or bends in the middle of the hub as the wheel heats up; this bending pushes the bearings out of the ends of the hub. Second, plastic hubs do not have the necessary toughness to carry loads above 1,200 lbs. Plastic hubs will crack and break because they cannot take torque load, nor do they have sufficient impact resistance necessary for everyday use.

By using a distributive load configuration as in FIGS. 1-3, will eliminate the bending of the hub, and increase the maximum load carried to 2,800 lbs. Using an inner core hub will increase the maximum load to 5,800 lbs. The inner core will also improve the torque and impact resistance of the load wheel by distributing the force across the face of the wheel.

Another benefit is that, unlike metal, plastic is poor heat conductor. In fact, plastic often acts as an insulator. As a result, a plastic hub can act as an insulator between the heat generating parts of the wheel and the adhesive bond line or tread material. The bearing, being in direct contact with the metal shaft, is a significant generator of heat in a load wheel. When pressed into a plastic hub, the heat generated from the bearing does not readily pass from the hub to the adhesive or tread material. Similarly, in the case of a hub with an inner core made of plastic will also act as an insulator from the shaft to the adhesive and tread material. The insulation properties of the plastic further mitigates the heat build up in the load wheel, and thereby increases the service life of the load wheel.

The use of plastic to make the hub provides the option of eliminating the need for an adhesive or cement to bond tread material to the hub. The outer diameter of plastic hubs can be easily and cost effectively be molded to into include holes, dimples, grooves, ribs and other protrusions and/or cavities that will provide a mechanical lock to the tread material. The mechanical lock eliminates the need for adhesive or cement. Mechanical locks notwithstanding, an adhesive might be used for hubs made out of low surface energy plastics, such as poly-olefins like polyethylene, polybutylene, polybutene, polypropylene, or when the combination of both methods of attachment are necessary. Elimination of the adhesive expands utility of high temperature tread materials that can resist higher temperature but are of no avail because the adhesive commonly used for load wheels fail below the ultimate temperature of the tread materials.

### SUMMARY OF THE INVENTION

In accordance with preferred embodiment of this invention, it is now possible to increase the service life of load wheels by reducing the running temperature, or reducing the rate of increase in running temperature by distributing the load across the face of the wheel. In addition, it is possible to increase the load carrying capacity of load wheels with plastic hubs. It is now possible to eliminate the use of adhesive to bond the tread material to the hub. The elimination of adhesive expands the range of tread materials that can be used on a hub because the upper failure temperature of the adhesive is no longer a factor with a hub providing a mechanical lock to attach the tread material.

### BRIEF DESCRIPTION OF THE DRAWINGS

FIG. 1 is an isometric view of a distributed load wheel.

FIG. 2 is an exploded view of a distributed load wheel.

FIG. 3 is a cross sectional view of a distributed load wheel.

FIG. 4 is a cross sectional view of a prior art load wheel.

FIG. 5 is an exploded view of prior art load wheel.

FIG. 6 is an isometric view of a prior art load wheel.

FIG. 7 is an isometric view of an inner core load wheel.

FIG. 8 is a top view of an inner core load wheel.

FIG. 9 is a front view of an inner core load wheel.

FIGS. 10-16 are isometric view of inner core hubs with or without a center circumferential support member and different mechanical attachment means.

### DESCRIPTION OF THE PREFERRED EMBODIMENT

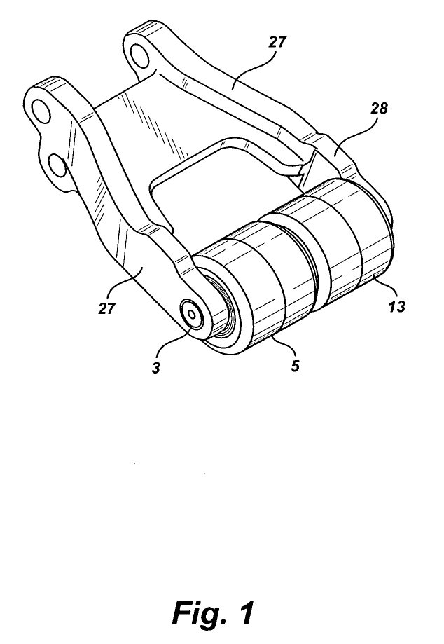

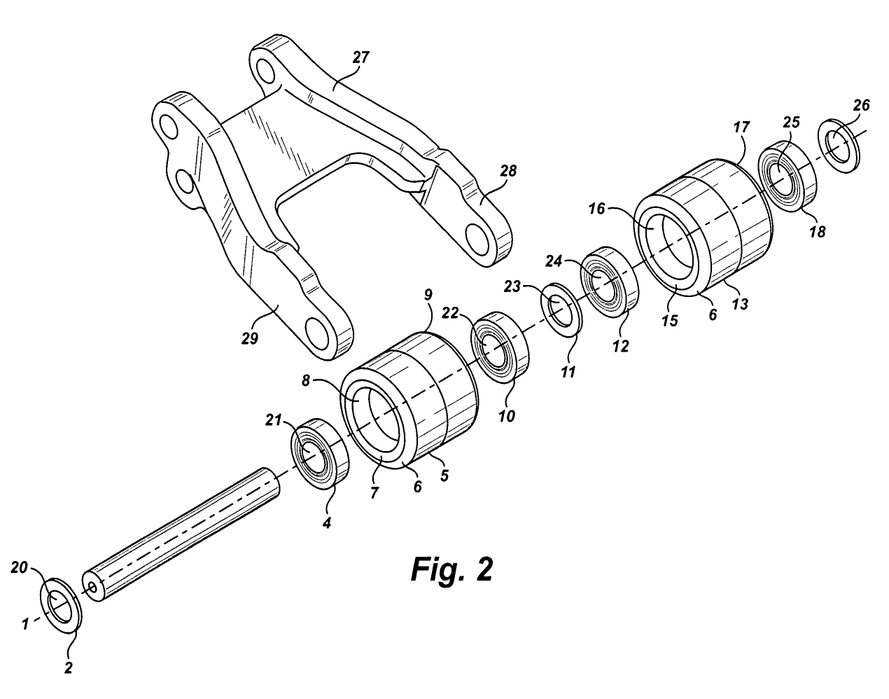

The following example is submitted to illustrate but not to limit this invention. Referring to FIG. 1, as a first embodiment of the invention, a distributive load wheel assembly contains a load-wheel-shaft assembly comprising a first wheel 5 and a second wheel 13 mounted on a shaft 3 installed into a mounting yoke 27 between the yoke armatures 28 and 29. Referring to FIG. 2, the load-wheel-shaft assembly further comprises a first load wheel 5 with a first bearing 4 press fitted into the outside inner diameter 8 of the first load wheel's 5 hub 7. A second bearing 10 press fitted into the first load wheel's 5 inside inner diameter 9 of the first load wheel's hub 7. A third bearing 12 press fitted into the inside inner diameter 16 of the second load wheel's 13 hub 15. A forth bearing 18 press fitted into the inside diameter 17 of the second load wheel's 13 outside inner diameter 17 hub 15. A first shim 2 is placed next to the first bearing 4. A second shim 11 is placed next to either the second bearing 10 or the third bearing 12. A third shim 19 is place next to the fourth bearing 18. A shaft 3 is sliding fitted along Axis 1 through the inner diameters 20, 21, 22, 23, 24, 25, and 26 of the first shim 2, the first bearing 4, the second bearing 10, the second shim 11, the third bearing 12, the forth bearing 18, and the third shim 19, respectively.

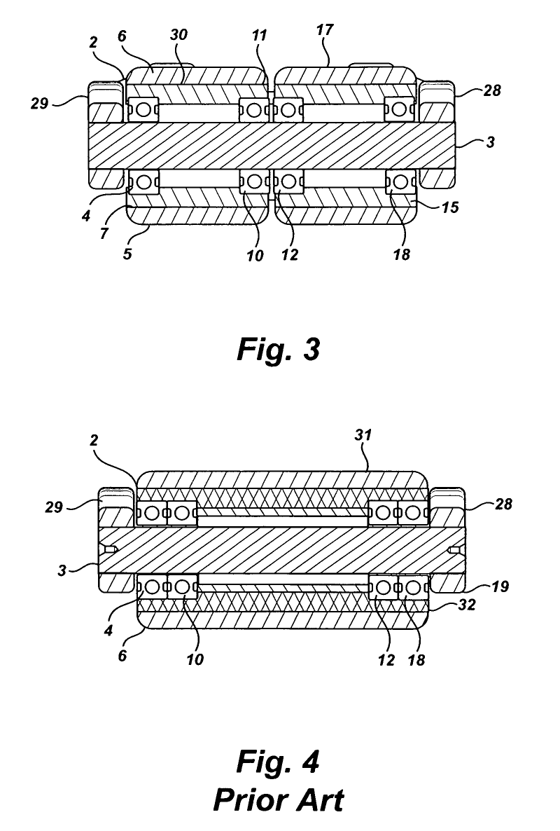

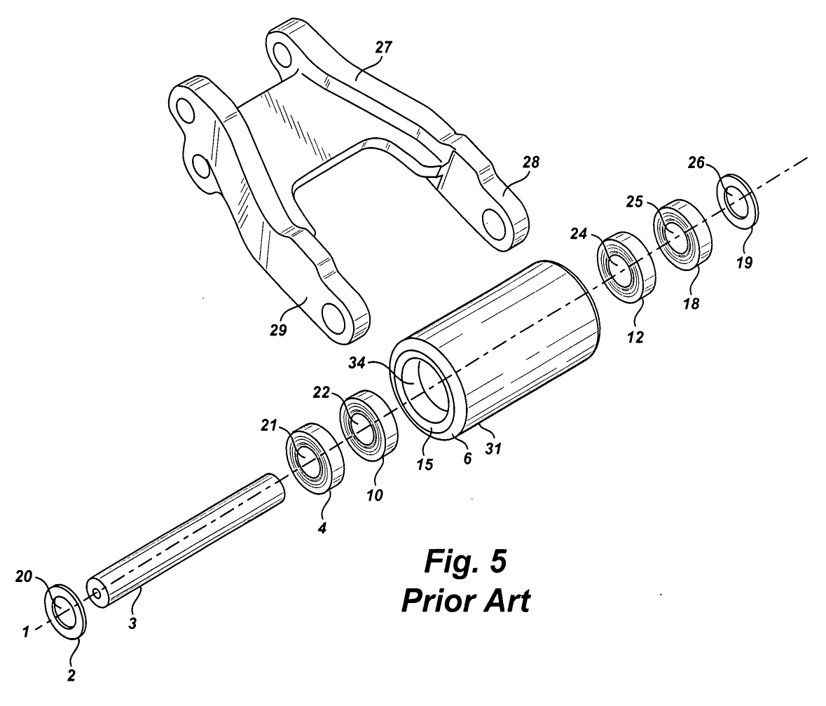

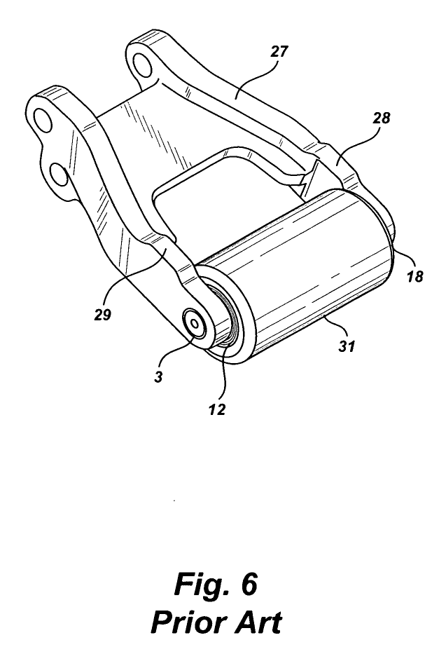

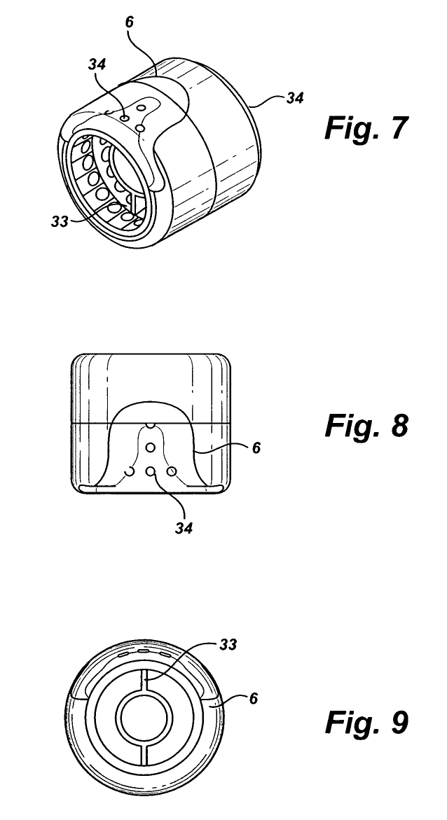

Referring to FIG. 3, and using the first load wheel 5 as an example, a load wheel comprises a hub 7 coated with a tread material 6. As in FIG. 4, a prior art load wheel 31 comprises a hub 32 coated with a tread material 6. A prior art load wheel, FIG. 4, further comprises an adhesive 30 to bond the tread material 6 to the hub 32. In a second embodiment of the invention, where the hubs 7 and 15 are made of metal, the use of an adhesive 30 is necessary to bond the tread material 6 to the metal hubs 7 and 15.

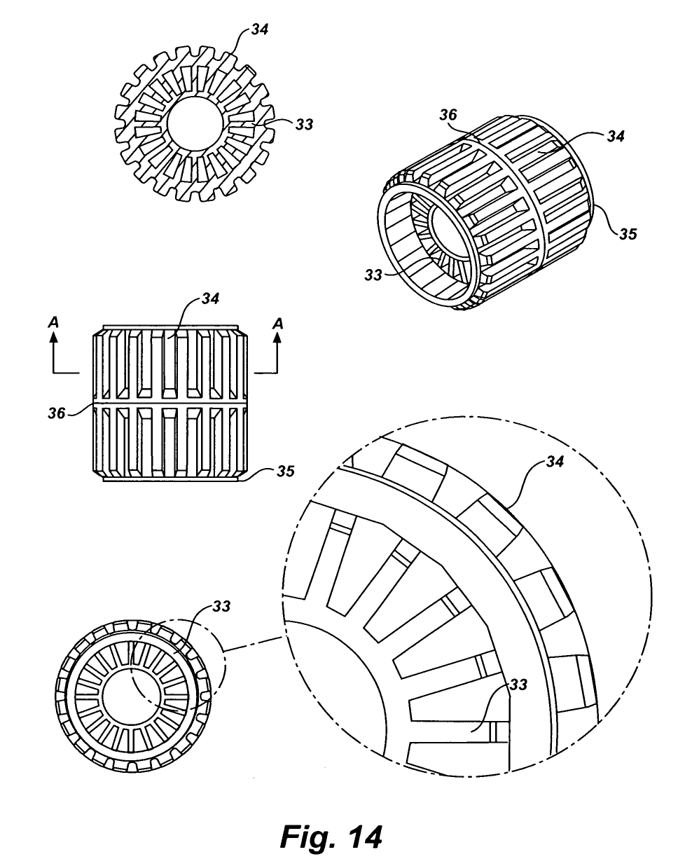

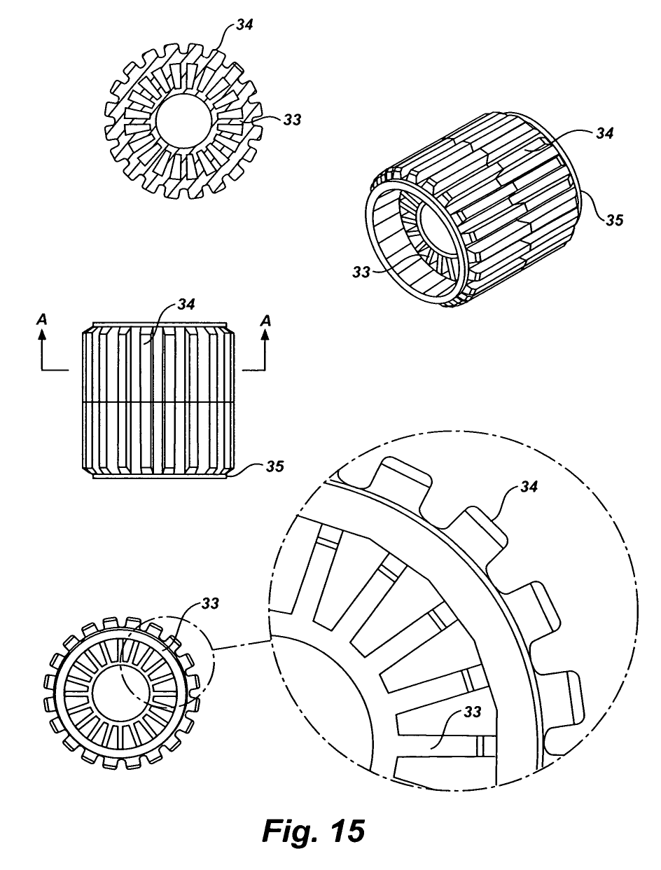

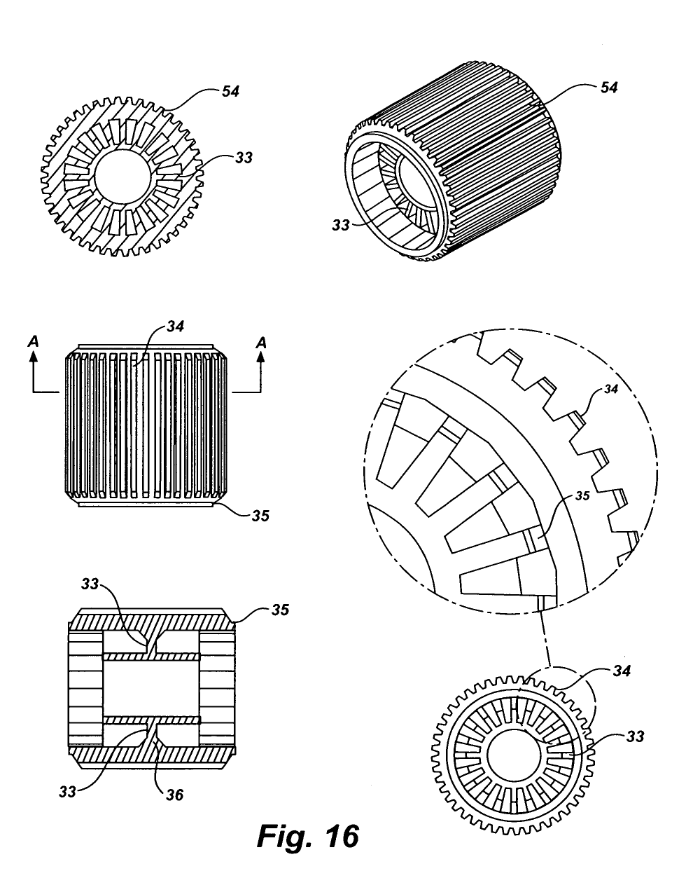

Referring to FIG. 2, using the first load wheel 5 as an example of a hub 7 without an inner core. In a third embodiment of the invention, an inner core hub 35 is used in place of the hubs 7 and 15. Referring to FIGS. 14 and 16, an inner core hub 35 is made up of a center core support member 33 inside the inner diameter of the inner core hub 35, and a center circumferential support 36 running about the inner or outer diameter of the inner core hub 35. In a fourth embodiment of the invention, an inner core hub 35 is used in place of the hubs 7 and 15. Referring to FIGS. 10-3 and 15, an inner core hub 35 is made up of a center core support member 33 inside the inner diameter of the inner core hub 35.

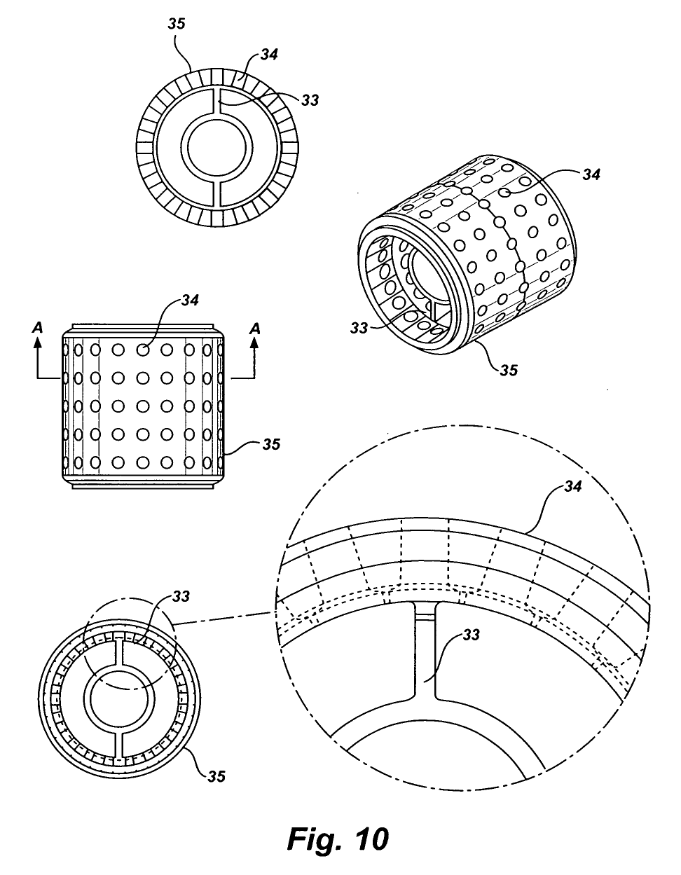

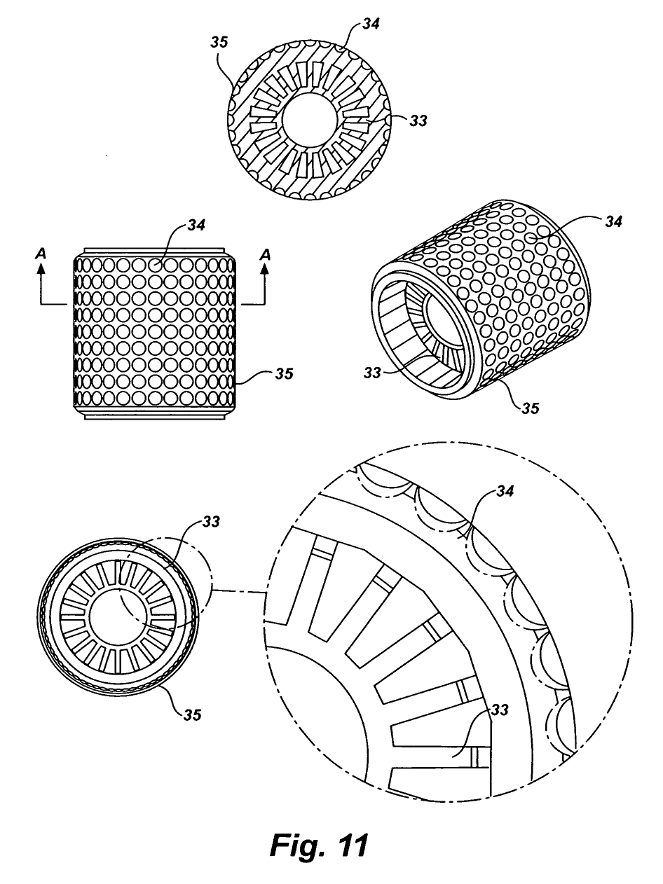

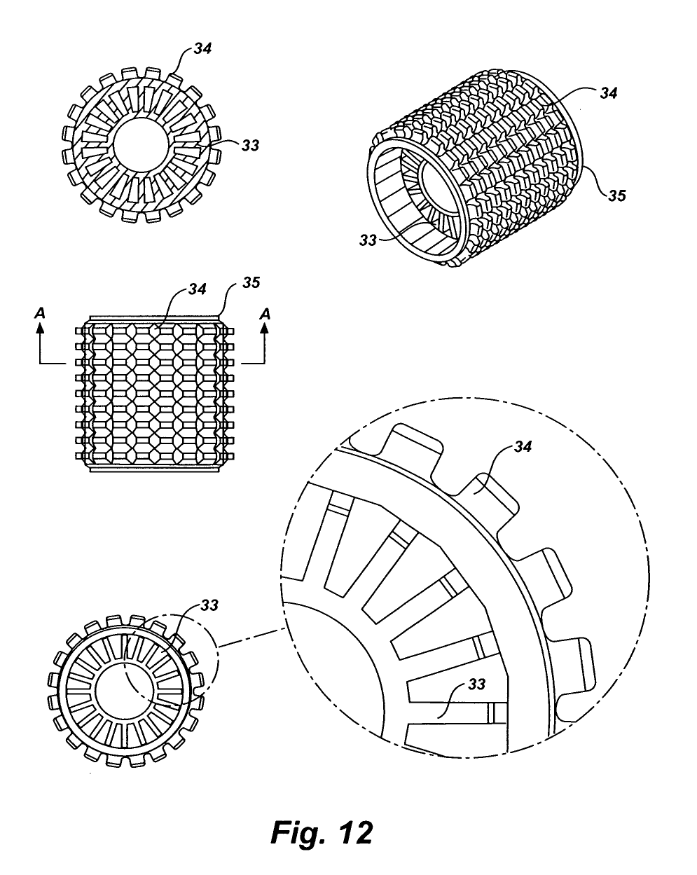

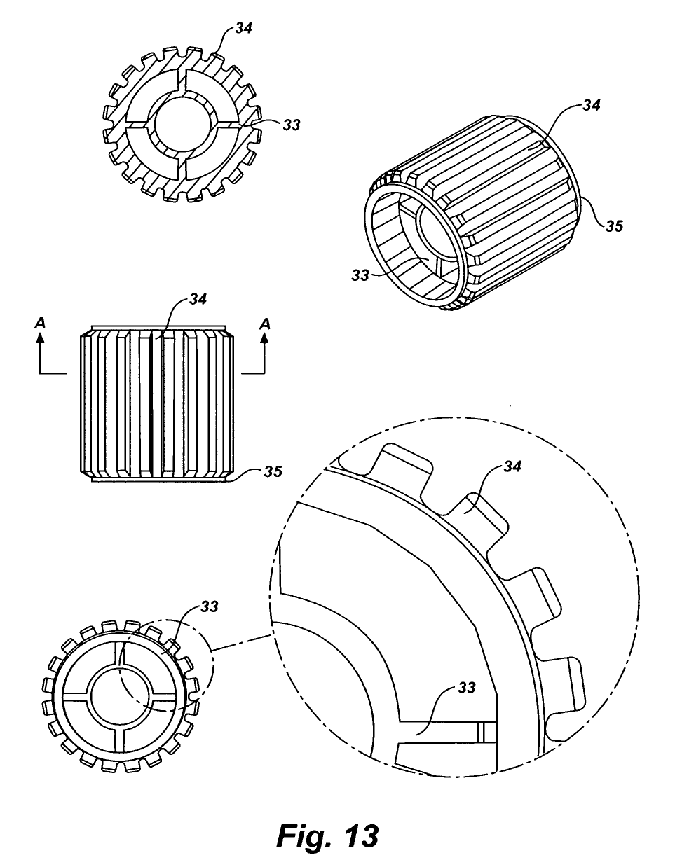

FIGS. 10-13 and FIG. 15 provide examples of various embodiments of an inner core hub 35 and a central core support member, 33. FIGS. 10-16 also provide several examples of the means by which a mechanical lock could be formed on the outer diameter of the hub. The mechanical locking means 34 is used to hold the tread material 6 fast to the hub. Using these mechanical locking means 34, no adhesive 30 would be necessary to bond the tread material 6 to the hubs 7, 15, 32, or 33.

Having set forth the general nature and specific embodiments of the present invention, the true scope is now particularly pointed in the appended claims.

What is claimed is:

1) A distributive load wheel assembly comprising:
a) at least two load wheels wherein each of said load wheel further comprises a hollow cylindrical hub of any length having an inner diameter and an outer diameter and open at both ends; and a tread material attached to said outer diameter along the length of said hub; and said tread material is selected from the group consisting of: vulcanizable elastomer, moldable thermoplastic elastomer, polyurethane, polyurethane elastomer, polypropylene, polyethylene, polybutene, polybutylene, ABS, or polyester; and
b) at least one bearing per said load wheel wherein each of said bearings has an inner diameter and an outer diameter wherein said outer diameter is less than the inner diameter of said hub; and of sufficient outer diameter to allow said bearing to be press fitted into said hub; and
c) wherein each of said load wheel has at least one of said bearings press fitted into the inner diameter of each end of said hub; and
d) a shaft having a first end and a second end; and an outer diameter less than the inner diameter of said bearing but of sufficient outer diameter to allow the shaft to be sliding fitted through the inner diameter of said bearing; and wherein said shaft's length is greater than the combined length of both load wheels when laid end to end so that said first end and said second end of said shaft extend beyond the combined length of said load wheels; and
e) at least one shim of any thickness wherein said shim has an inner diameter and an outer diameter; wherein said inner diameter of said shim is greater than the outer diameter of said shaft and allows a sliding fit through the inner diameter of said shim and the outer diameter of said shaft; and
f) wherein said shaft is sliding fitted through said inner diameter of said bearing press fitted into one end of said first load wheel; and wherein said shaft sliding fitted through the inner diameter of said shim; and wherein said shaft is sliding fitted through inner diameter of said bearing press fitted into one end of said second load wheel; and wherein said first end and second end of said shaft extend beyond the combined length of both load wheels.

2) The distributive load wheel assembly of claim 1 wherein said hollow cylindrical hub is made of metal selected from the group consisting of: cast iron, steel, stainless steel, cast steel, aluminum, copper, copper alloys, or zinc.

3) The distributive load wheel assembly of claim 1 wherein said hollow cylindrical hub is made of a filled engineering thermoplastic resin selected from the group consisting of: at least 5% filled polyamide, polyester, polypropylene, polyetherimide, or polyetheretherketone; and wherein said filler is selected from the group consisting of chopped glass, glass fibers, talc, calcium carbonate, aramid, carbon black, carbon fibers, metal, Teflon, silicon, sand, or nano-fibers.

4) The distributive load wheel assembly of claim 1 wherein said hollow cylindrical hub is made of an unfilled engineering thermoplastic resin selected from the group consisting of: polyamide, polyester, polypropylene, polyetherimide, or polyetheretherketone.

5) The distributive load wheel assembly of claim 1 wherein said hollow cylindrical hub is made of a filled engineering thermoset resin selected from the group consisting of: at least 5% filled polyester, epoxy, novolac phenolic, resole phenolic, polyurethane, or diallyl phthalate; and wherein said filler is selected from the group consisting of chopped glass, glass fibers, talc, calcium carbonate, aramid, carbon black, carbon fibers, metal, Teflon, silicon, sand, or nano-fibers.

6) The distributive load wheel assembly of claim 1 wherein said hollow cylindrical hub is made of an unfilled engineering thermoset resin selected from the group consisting of: polyester, epoxy, novolac phenolic, resole phenolic, polyurethane, or diallyl phthalate.

7) A distributive load wheel assembly as in any one of claims 1-6 wherein a mechanical attachment means is provided on the outside diameter of said hub allowing for mechanical attachment of said tread material to said hub.

8) A distributive load wheel assembly as in any one of claims 1-6 wherein an adhesive is applied to the outer diameter of said hub to attach said tread material to the outer diameter of said hub.

9) A center supported inner core hub comprising:
a) an outer hollow cylinder of any length, having an inner diameter and an outer diameter, and is open at both ends; and has an inner core located within the inner diameter of the outer hollow cylinder;
b) wherein said inner core further comprises a center core support member being a hollow cylinder of any length with an inner diameter and an outer diameter; and said inner diameter and said outer diameter of said hollow cylinder is concentric with the inner diameter and outer diameter of said outer hollow cylinder; and is attached to the inner diameter of said outer hollow cylinder by at least one rib; and
c) a center circumferential support further comprising a support means running in a concentric circle about the inner or outer diameter of said outer hollow cylinder.

10) The center supported inner core hub of claim 9 wherein said center supported inner core hub is made of a filled engineering thermoplastic resin; and wherein said filled engineering thermoplastic resin is selected from the group consisting of: at least 5% filled polyamide, polyester, polypropylene, polyetherimide, or polyetheretherketone; and wherein said filler is selected from the group consisting of: chopped glass, glass fibers, talc, calcium carbonate, aramid, carbon black, carbon fibers, metal, Teflon, silicon, sand, or nano-fibers.

11) The center supported inner core hub of claim 9 wherein said center supported inner core hub is made of an unfilled engineering thermoplastic resin; and wherein said unfilled engineering thermoplastic resin is selected from the group consisting of: polyamide, polyester, polypropylene, polyetherimide, or polyetheretherketone.

12) The center supported inner core hub of claim 9 wherein said center supported inner core hub is made of a filled thermoset resin; and wherein said filled thermoset resin is selected from the group consisting of: at least 5% filled polyester, epoxy, novolac phenolic, resole phenolic, polyurethane, or diallyl phthalate; and wherein said filler is selected from the group consisting of: chopped glass, glass fibers, talc, calcium carbonate, aramid, carbon black, carbon fibers, metal, Teflon, silicon, sand, or nano-fibers.

13) The center supported inner core hub of claim 9 wherein said center supported inner core hub is made of an unfilled thermoset resin wherein said unfilled thermoset resin is selected from the group consisting of: polyester, epoxy, novolac phenolic, resole phenolic, polyurethane, or diallyl phthalate.

14) The center supported inner core hub of claim 9 wherein said center supported inner core hub is made of metal selected from the group consisting of: cast iron, steel, stainless steel, cast steel, aluminum, copper, copper alloys, or zinc.

15) An inner core center supported load wheel comprising: a center supported inner core hub as in any one of claims 9-14 further comprising a tread material attached to the outer diameter of the outer hollow cylinder along the length of said outer hollow cylinder; wherein said tread material is selected from the group consisting of: vulcanizable elastomer, moldable thermoplastic elastomer, polyurethane, polyurethane elastomer, polypropylene, polyethylene, polybutene, polybutylene, ABS, or polyester; and wherein a mechanical attachment means is provided on the outer diameter of the outer hollow cylinder to attach said tread material.

16) An inner core center supported load wheel comprising: a center supported inner core hub as in as in any one of claims 9-14 further comprising a tread material attached to the outer diameter of the outer hollow cylinder along the length of said outer hollow cylinder; wherein said tread material is selected from the group consisting of: vulcanizable elastomer, moldable thermoplastic elastomer, polyurethane, polyurethane elastomer, polypropylene, polyethylene, polybutene, polybutylene, ABS, or polyester; and wherein an adhesive applied on the outer diameter of the outer hollow cylinder to attach said tread material.

17) A distributive load wheel assembly comprising:
a) at least one load wheel; and wherein said load wheel is an inner core center supported load wheel as in claim 15; and
b) at least one bearing per said load wheel wherein each of said bearings has an inner diameter and an outer diameter wherein said outer diameter is less than the inner diameter of said hub; and of sufficient outer diameter to allow said bearing to be press fitted into said hub; and
c) wherein each of said load wheel has at least one of said bearings press fitted into the inner diameter of each end of said hub; and
d) a shaft having a first end and a second end; and an outer diameter less than the inner diameter of said bearing but of sufficient outer diameter to allow the shaft to be sliding fitted through the inner diameter of said bearing; and wherein said shaft's length is greater than the combined length of both load wheels when laid end to end so that said first end and said second end of said shaft extend beyond the combined length of said load wheels; and
e) at least one shim of any thickness wherein said shim has an inner diameter and an outer diameter; wherein said inner diameter of said shim is greater than the outer diameter of said shaft and allows a sliding fit through the inner diameter of said shim and the outer diameter of said shaft; and
f) wherein said shaft is sliding fitted through said inner diameter of said bearing press fitted into one end of said first load wheel; and wherein said shaft sliding fitted through the inner diameter of said shim; and wherein said shaft is sliding fitted through inner diameter of said bearing press fitted into one end of said second load wheel; and wherein said first end and second end of said shaft extend beyond the combined length of both load wheels.

18) A distributive load wheel assembly comprising:
a) at least one load wheel; and wherein said load wheel is an inner core center supported load wheel as in claim 16; and
b) at least one bearing per said load wheel wherein each of said bearings has an inner diameter and an outer diameter wherein said outer diameter is less than the inner diameter of said hub; and of sufficient outer diameter to allow said bearing to be press fitted into said hub; and
c) wherein each of said load wheel has at least one of said bearings press fitted into the inner diameter of each end of said hub; and
d) a shaft having a first end and a second end; and an outer diameter less than the inner diameter of said bearing but of sufficient outer diameter to allow the shaft to be sliding fitted through the inner diameter of said bearing; and wherein said shaft's length is greater than the combined length of both load wheels when laid end to end so that said first end and said second end of said shaft extend beyond the combined length of said load wheels; and
e) at least one shim of any thickness wherein said shim has an inner diameter and an outer diameter; wherein said inner diameter of said shim is greater than the outer diameter of said shaft and allows a sliding fit through the inner diameter of said shim and the outer diameter of said shaft; and
f) wherein said shaft is sliding fitted through said inner diameter of said bearing press fitted into one end of said first load wheel; and wherein said shaft sliding fitted through the inner diameter of said shim; and wherein said shaft is sliding fitted through inner diameter of said bearing press fitted into one end of said second load wheel; and wherein said first end and second end of said shaft extend beyond the combined length of both load wheels.

19) An inner core hub comprising:
a) an outer hollow cylinder of any length, having an inner diameter and an outer diameter, and is open at both ends; and has an inner core located within the inner diameter of the outer hollow cylinder;
b) wherein said inner core further comprises a center core support member being a hollow cylinder of any length with an inner diameter and an outer diameter; and said inner diameter and said outer diameter of said hollow cylinder is concentric with the inner diameter and outer diameter of said outer hollow cylinder; and is attached to the inner diameter of said outer hollow cylinder by at least one rib.

20) The inner core hub of claim 19 wherein said inner core hub is made of a filled engineering thermoplastic resin; and wherein said filled engineering thermoplastic resin is selected from the group consisting of: at least 5% filled polyamide, polyester, polypropylene, polyetherimide, or polyetheretherketone; and wherein said filler is selected from the group consisting of: chopped glass, glass fibers, talc, calcium carbonate, aramid, carbon black, carbon fibers, metal, Teflon, silicon, sand, or nano-fibers.

21) The inner core hub of claim 19 wherein said inner core hub is made of an unfilled engineering thermoplastic resin; and wherein said unfilled engineering thermoplastic resin is selected from the group consisting of: polyamide, polyester, polypropylene, polyetherimide, or polyetheretherketone.

22) The inner core hub of claim 19 wherein said inner core hub is made of a filled thermoset resin; and wherein said filled thermoset resin is selected from the group consisting of: at least 5% filled polyester, epoxy, novolac phenolic, resole phenolic, polyurethane, or diallyl phthalate; and wherein said filler is selected from the group consisting of: chopped glass, glass fibers, talc, calcium carbonate, aramid, carbon black, carbon fibers, metal, Teflon, silicon, sand, or nano-fibers.

23) The inner core hub of claim 19 wherein said inner core hub is made of an unfilled thermoset resin wherein said unfilled thermoset resin is selected from the group consisting of: polyester, epoxy, novolac phenolic, resole phenolic, polyurethane, or diallyl phthalate.

24) The inner core hub of claim 19 wherein said inner core hub is made of metal selected from the group consisting of: cast iron, steel, stainless steel, cast steel, aluminum, copper, copper alloys, or zinc.

25) An inner core load wheel comprising: an inner core hub as in as in any one of claims 19-24 further comprising a tread material attached to the outer diameter of the outer hollow cylinder along the length of said outer hollow cylinder; wherein said tread material is selected from the group consisting of: vulcanizable elastomer, moldable thermoplastic elastomer, polyurethane, polyurethane elastomer, polypropylene, polyethylene, polybutene, polybutylene, ABS, or polyester; and wherein a mechanical attachment means is provided on the outer diameter of the outer hollow cylinder to attach said tread material.

26) An inner core load wheel comprising: an inner core hub as in as in any one of claims 19-24 further comprising a tread material attached to the outer diameter of the outer hollow cylinder along the length of said outer hollow cylinder; wherein said tread material is selected from the group consisting of: vulcanizable elastomer, moldable thermoplastic elastomer, polyurethane, polyurethane elastomer, polypropylene, polyethylene, polybutene, polybutylene, ABS, or polyester; and wherein an adhesive applied on the outer diameter of the outer hollow cylinder to attach said tread material.

27) A distributive load wheel assembly comprising:
a) at least one load wheel; and wherein said load wheel is an inner core load wheel as in claim 25; and
b) at least one bearing per said load wheel wherein each of said bearings has an inner diameter and an outer diameter wherein said outer diameter is less than the inner diameter of said hub; and of sufficient outer diameter to allow said bearing to be press fitted into said hub; and
c) wherein each of said load wheel has at least one of said bearings press fitted into the inner diameter of each end of said hub; and
d) a shaft having a first end and a second end; and an outer diameter less than the inner diameter of said bearing but of sufficient outer diameter to allow the shaft to be sliding fitted through the inner diameter of said bearing; and wherein said shaft's length is greater than the combined length of both load wheels when laid end to end so that said first end and said second end of said shaft extend beyond the combined length of said load wheels; and
e) at least one shim of any thickness wherein said shim has an inner diameter and an outer diameter; wherein said inner diameter of said shim is greater than the outer diameter of said shaft and allows a sliding fit through the inner diameter of said shim and the outer diameter of said shaft; and
f) wherein said shaft is sliding fitted through said inner diameter of said bearing press fitted into one end of said first load wheel; and wherein said shaft sliding fitted through the inner diameter of said shim; and wherein said shaft is sliding fitted through inner diameter of said bearing press fitted into one end of said second load wheel; and wherein said first end and second end of said shaft extend beyond the combined length of both load wheels.

28) A distributive load wheel assembly comprising:
a) at least one load wheel; and wherein said load wheel is an inner core load wheel as in claim 26; and
b) at least one bearing per said load wheel wherein each of said bearings has an inner diameter and an outer diameter wherein said outer diameter is less than the inner diameter of said hub; and of sufficient outer diameter to allow said bearing to be press fitted into said hub; and
c) wherein each of said load wheel has at least one of said bearings press fitted into the inner diameter of each end of said hub; and
d) a shaft having a first end and a second end; and an outer diameter less than the inner diameter of said bearing but of sufficient outer diameter to allow the shaft to be sliding fitted through the inner diameter of said bearing; and wherein said shaft's length is greater than the combined length of both load wheels when laid end to end so that said first end and said second end of said shaft extend beyond the combined length of said load wheels; and
e) at least one shim of any thickness wherein said shim has an inner diameter and an outer diameter; wherein said inner diameter of said shim is greater than the outer diameter of said shaft and allows a sliding fit through the inner diameter of said shim and the outer diameter of said shaft; and
f) wherein said shaft is sliding fitted through said inner diameter of said bearing press fitted into one end of said first load wheel; and wherein said shaft sliding fitted through the inner diameter of said shim; and wherein said shaft is sliding fitted through inner diameter of said bearing press fitted into one end of said second load wheel; and wherein said first end and second end of said shaft extend beyond the combined length of both load wheels.

29) A method of using the distributive load wheel assembly as in any one of claims 1-6, or 17, 18, 27 28, or by installing said distributive load wheel assembly into a Class III or Class II material handling vehicle and operating said vehicle in accordance with its design.

30) A method of using an inner core load wheel as in any one of claims 15, 16, 25, or 26 by installing said inner core load wheel into a Class III or Class II material handling vehicle and operating said vehicle in accordance with its design.
